(19) United States
(12) Patent Application Publication
(10) Pub. No.: US 2008/0209321 A1
(43) Pub. Date: Aug. 28, 2008

(54) Mobile terminal apparatus, and display control method therefor

(75) Inventors: Kazuyuki Sato, Kawasaki (JP); Takako Yamaguchi, Kawasaki (JP); Atsumasa Tsuyuki, Kawasaki (JP); Toshimitsu Kumagai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/071,051

(22) Filed: Feb. 14, 2008

(30) Foreign Application Priority Data
Feb. 15, 2007 (JP) 2007-34255

(51) Int. Cl. G06F 3/00

(52) U.S. Cl. 715/700

(57) ABSTRACT

In the state when the schedule function is activated, when a rotational motion of a display unit using a rotating mechanism thereof is detected, or when an acceleration of a predetermined acceleration value or greater is detected, the mobile terminal apparatus modifies the schedule display based on the above detection. Specifically, the mobile terminal apparatus modifies either the displayed schedule period or the display magnification factor of the display content.

### CROSS-REFERENCE TO RELATED APPLICATIONS

This application is based upon and claims the benefit of priority from the prior Japanese Patent Application No. 2007-34255, filed on Feb. 15, 2007, the entire contents of which are incorporated herein by reference.

### BACKGROUND OF THE INVENTION

1. Field of the Invention

The present invention relates to a mobile terminal apparatus having a schedule function, and more particularly, a mobile terminal apparatus enabling arbitrary modification of a schedule display content by a simple operation, and a display control method for the mobile terminal apparatus.

2. Description of the Related Art

In recent years, a mobile terminal apparatus such as a mobile phone has increasingly improved hardware performance (in view of CPU performance, memory capacity, etc.) and advanced functions required from the market (that is, users). In such the situation, the mobile terminal apparatus is provided with a schedule function to store and display a schedule registered from the users. Meanwhile, mainly because the display items increase as the schedule functions are extended, it is not possible to entirely display the registered schedule contents in the display screen region having a limited area. Therefore, it is necessary for the users to select or switch the display contents by means of predetermined key operations. Further, it has been proposed to incorporate an automatic switchover function of the display contents at predetermined switchover time intervals (in the official gazette of the Japanese Unexamined Patent Publication No. 2002-91928).

As another mobile terminal apparatus, there has been developed and commercially used a mobile terminal apparatus having a mechanism of a display unit being rotatable from a direction with the long sides vertically disposed (which is hereafter referred to as vertical position direction) to a direction with the long sides horizontally disposed (which is hereafter referred to as horizontal position direction).

FIG. 1 shows a diagram illustrating an exemplary mobile terminal apparatus having a rotatable display unit. The mobile terminal apparatus shown in FIG. 1 is a foldable mobile terminal apparatus. In the open state thereof, a display unit 105 can be shifted from a vertical position state, which is a state in ordinary disposition, to a horizontal position state by the rotational motion to the left side as shown in FIG. 1, or to the horizontal position state by the rotational motion to the right side i.e. to the direction opposite to FIG. 1.

Such the mobile terminal apparatus having a rotating mechanism of the display unit includes a mechanism for detecting a rotational motion, and according to the detected rotational motion, a variety of built-in functions can be initiated in response to the respective rotational motions of display unit 105. For example, when display unit 105 is rotated to the left side, a mail function is initiated, and thereby a received mail list is displayed on display unit 105, while when display unit 105 is rotated to the right side, a photography function of a still image by means of a built-in camera (not shown) is initiated, and thereby an image from the built-in camera is displayed on display unit 105. Here, the functions to be initiated can be modified arbitrarily by the setting, and different functions can be assigned, depending on the case when rotated to the left side or when rotated to the right side.

As described above, when the schedule contents managed by the schedule function of the mobile terminal apparatus are to be displayed on display unit 105, when the schedule period to be displayed is set long (for example, one month), it is not possible to display the entire schedule contents due to the limited display area of the display unit. Meanwhile, when the schedule period to be displayed is set short (for example, one week), it becomes impossible for the user to confirm the entire schedule month-by-month, as an example, which compels the user to switch the display contents frequently for confirming the schedule. However, whenever the display connects are to be switched, the user is required to execute troublesome key operations such as an operation of depressing a small key. Thus, the user is compelled to execute troublesome operations.

### SUMMARY OF THE INVENTION

Accordingly, it is an object of the present invention to provide a mobile terminal apparatus having improved operability of a schedule function, and a display control method therefor. More specifically, it is an object of the present invention to improve the operability of the schedule function by enabling switching of the schedule display contents without key operation, using the aforementioned rotating mechanism of the display unit, etc.

In order to achieve the aforementioned object, according to the present invention, a mobile terminal apparatus includes a rotating mechanism of a display unit enabling the display unit to rotate from the vertical position direction to the horizontal position direction, and by means of a user operation to rotate the display unit, the display unit can be rotated to the left side or to the right side, so as to be shifted from the vertical position state to the horizontal position state as shown in FIG. 1 above, and can be restored from the horizontal position state to the vertical position state.

Further, as a swing detection means, the mobile terminal apparatus includes a rotation detector for detecting the rotation of the display unit by means of the above rotating mechanism of the display unit, and while the schedule function is activated, when the user performs a swing motion to rotate the display unit, and the rotation detector detects the above rotational motion, the mobile terminal apparatus includes a function to modify the schedule display based on the above detection. More specifically, the mobile terminal apparatus modifies a displayed schedule period, or a display magnification factor of the displayed content.

Further, when the mobile terminal apparatus according to the present invention includes an acceleration sensor as the swing detection means, when the user performs a swing motion to swing the mobile terminal apparatus, and the acceleration sensor detects a predetermined acceleration, the mobile terminal apparatus includes a function to modify the schedule display, based on the above detection.

Further, according to the present invention, in a display control method of a mobile terminal apparatus having a schedule function to store and display a schedule, the display control method includes: a display step for displaying the schedule on a display unit of the mobile terminal apparatus; a swing detection step for detecting a swing motion of the display unit; and a display control step for modifying a schedule period to be displayed on the display unit, when the swing motion of the display unit is detected in the swing detection step.

Also, there is provided a computer program to make the mobile terminal apparatus execute the display control method according to the present invention.

Further scopes and features of the present invention will become more apparent by the following description of the embodiments with the accompanied drawings.

### BRIEF DESCRIPTION OF THE DRAWINGS

FIG. 1 shows a diagram illustrating an exemplary mobile terminal apparatus having a rotatable display unit.

FIG. 2 shows a diagram illustrating an exemplary hardware configuration of a mobile terminal apparatus according to an embodiment of the present invention.

FIG. 3 shows a diagram illustrating a set screen to initiate a schedule function by the rotational motion of display unit 105.

FIG. 4 shows a diagram illustrating an exemplary screen displayed on display unit 105 according to the present invention, to modify a schedule period.

FIG. 5 shows a diagram illustrating an exemplary set screen to set a schedule period to be displayed by the rotational motion of display unit 105.

FIGS. 6A, 6B show diagrams illustrating examples of switchover of the schedule screen when a schedule period corresponding to a rotational motion is not set.

FIG. 7 shows a diagram explaining a motion to rotate display unit 105 so as to modify a display period.

FIG. 8 shows a diagram illustrating an exemplary modification sequence of a schedule display period to be displayed.

FIG. 9 shows a diagram illustrating an exemplary modification sequence of the display magnification factor of a schedule to be displayed.

FIG. 10 shows an exemplary schedule screen to be displayed with enlargement/reduction.

FIG. 11 shows an exemplary schedule screen to be displayed with enlargement/reduction.

FIG. 12 shows a diagram explaining a motion to vibrate a mobile terminal apparatus so as to modify a display period or a display magnification factor.

FIG. 13 shows a processing flowchart of a mobile terminal apparatus according to an embodiment of the present invention.

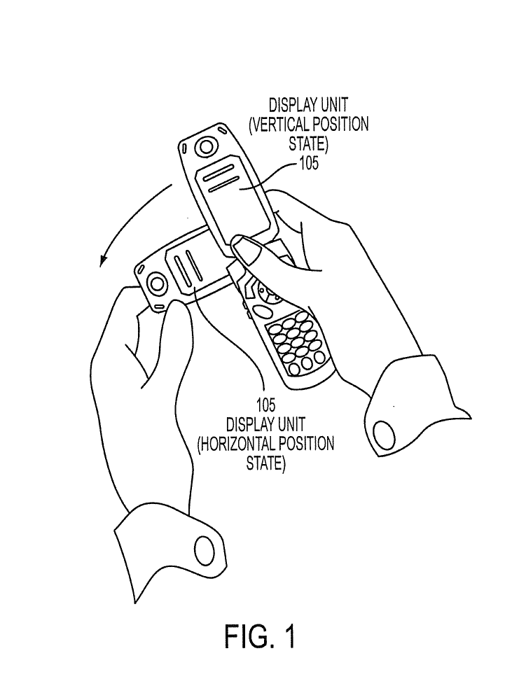

### DETAILED DESCRIPTION OF THE PREFERRED EMBODIMENTS

The embodiments of the present invention are described hereinafter, referring to the charts and drawings. However, it is noted that the embodiments described below are not intended to limit the scope of the present invention. In the present specification and claims, a “swing” motion is referred to a motion including both a rotational motion of the display unit and a vibrational motion of the mobile terminal apparatus. Further, the terms “vibration of the mobile terminal apparatus” and “vibration of the display unit” are regarded to have the same meaning, because when the mobile terminal apparatus is vibrated, the display unit provided on the mobile terminal apparatus is also vibrated. In the following, the embodiments of the present invention will be described in detail.

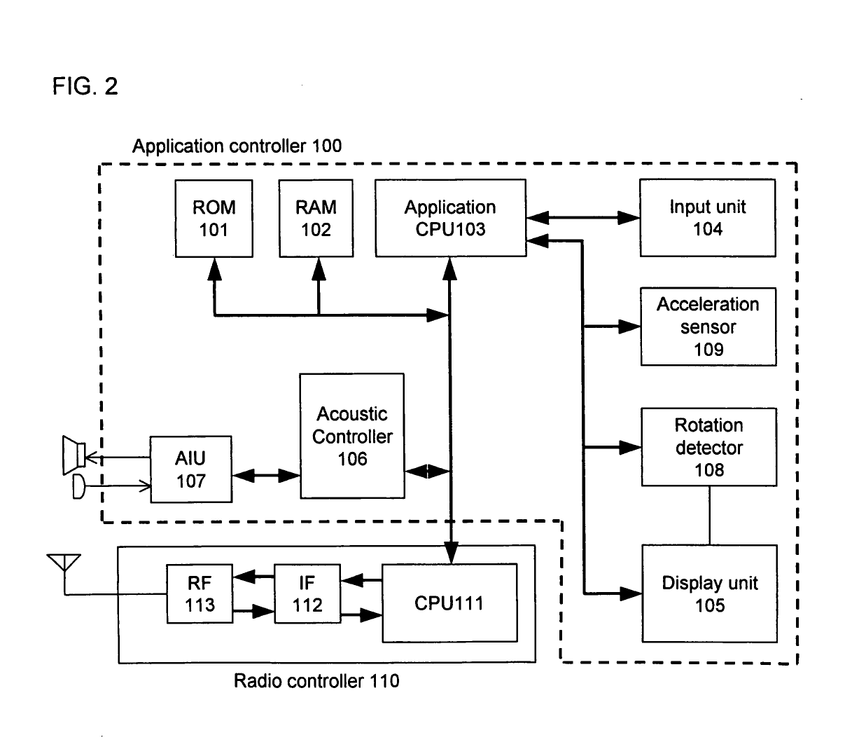

FIG. 2 shows a diagram illustrating an exemplary hardware configuration of a mobile terminal apparatus according to an embodiment of the present invention. The mobile terminal apparatus includes an application controller 100 and a radio controller 110. Application controller 100 includes a ROM 101 for storing an application program corresponding to a variety of functions such as a schedule function, and a RAM 102 for deploying the initiated application program. By means of an application CPU 103 executing the variety of application programs, a variety of kinds of functions are performed, and predetermined screen displays are made on a display unit 105, a liquid crystal display. An input unit 104 is constituted of key buttons, which are operated by a user.

Further, the mobile terminal apparatus includes a rotation detector 108 for detecting the rotational motion of display unit 105, and an acceleration sensor 109. Rotation detector 108 is provided for detecting the rotation of display unit 105 to the right or left direction by the rotating mechanism of the display unit of the mobile terminal apparatus, by which the direction of rotation (to the right or left direction) can be identified also. Rotation detector 108 may be constituted of a simple switch. Acceleration sensor 109 detects the vibration of the mobile terminal apparatus, by detecting the acceleration of the mobile terminal apparatus when the user swings the mobile terminal apparatus.

Also, there are provided an acoustic controller 106 for controlling an acoustic signal being input and output from/to a speaker and a microphone for speech communication, and an interface (AIU: audio interface unit) 107 with the speaker and the microphone. Further, radio controller 110 includes a CPU 111 for controlling transmission and reception of a radio signal in a variety of communication means such as telephone, electronic mail and Internet, as well as an interface 112, and a radio signal transmitter/receiver (RF) 113.

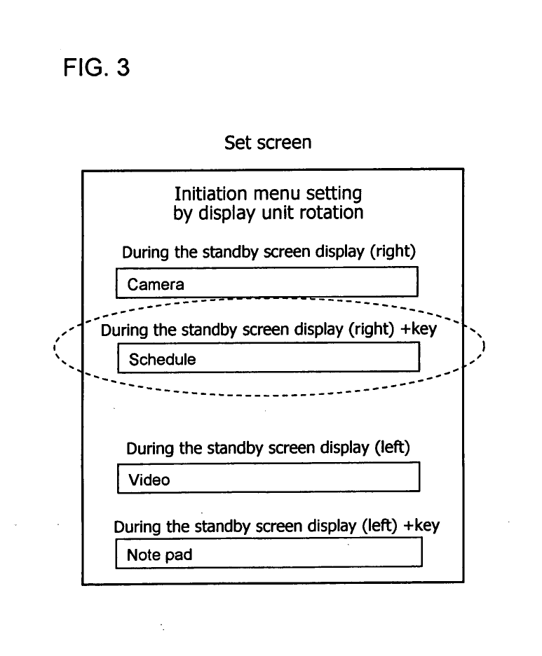

FIG. 3 shows a diagram illustrating a set screen to initiate a schedule function by the rotational motion of display unit 105. In the menu for setting a variety of functions, it is possible to set a function to be initiated by rotating display unit 105. In the example shown in FIG. 3, in a state of waiting for an incoming call (which is referred to as “standby state”), a camera function is initiated if display unit 105 in the vertical position state is rotated to the right side, and shifted into the horizontal position state. Meanwhile, in the state that a predetermined operation (for example, depression of a predetermined key button) to input unit 104 is being performed, a schedule function is initiated if display unit 105 in the vertical position state is rotated to the right side, and shifted into the horizontal position state. Namely, it is possible to assign a plurality of functions to the rotational motion of display unit 105 to the right side. In the set example shown in FIG. 3, when display unit 105 placed in the vertical position state is rotated to the left side, and shifted into the horizontal position state, a video function is initiated if a predetermined operation to input unit 104 is not being performed, while a note pad function is initiated if a predetermined operation to input unit 104 is being performed.

When rotation detector 108 detects the rotational motion of display unit 105 from the vertical position state to the horizontal position state, application CPU 103 decides whether a predetermined operation to input unit 104 is being performed, and selects a function to be initiated, based on both the direction of the rotational motion of display unit 105 and the presence or non-presence of the predetermined operation. In the example shown in FIG. 3, when rotation detector 108 detects the rotational motion of display unit 105 to the right side, the schedule function is initiated. Needless to say, the schedule function can also be initiated by an ordinary key operation only.

Display control processing in the state when the schedule function is active will be described in the following. The display control processing according to the present invention is realized by the execution of the schedule function in application CPU 103. Based on the detected rotational motion of display unit 105 by rotation detector 108, application CPU 103 modifies a schedule period displayed on display unit 105.

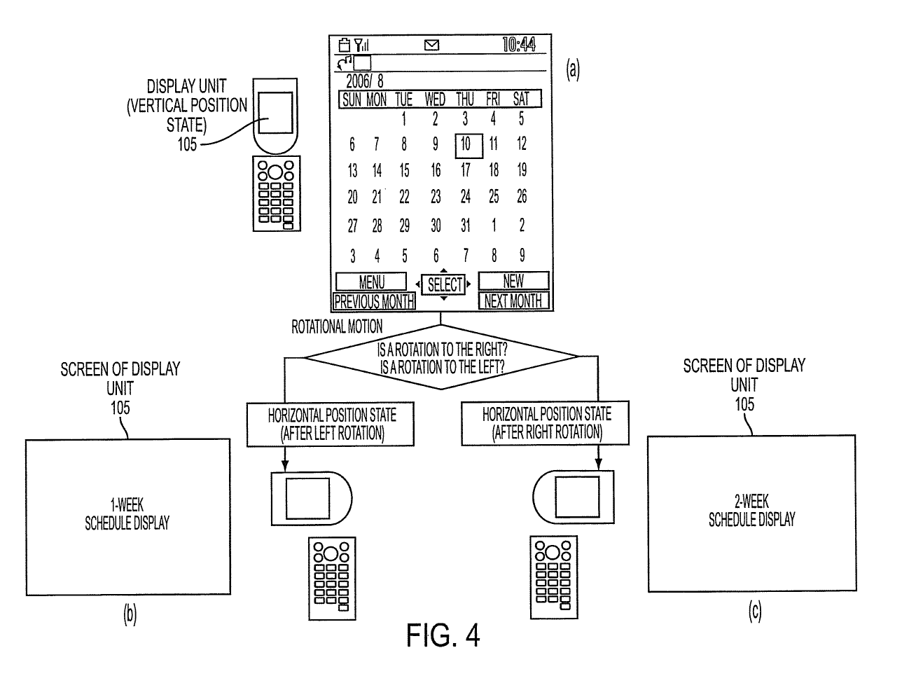

When the schedule function is initiated, for example, a schedule screen for the present month as shown by (a) in FIG. 4 is displayed, as a default screen.

FIG. 4 shows a diagram illustrating an exemplary screen displayed on display unit 105 according to the present invention, to modify a schedule period. In FIG. 4, (a) is an exemplary default screen at the time the schedule function is initiated, with display unit 105 placed in the vertical position state. When the screen shown by (a) in FIG. 4 is displayed, if a predetermined date is selected through an ordinary operation to input unit 104, the screen is switched to a screen on which the detailed schedule content of the selected date is displayed.

In first display control processing according to the embodiment of the present invention, when display unit 105 is rotated from the vertical position state to the horizontal position state, the screen is switched to a schedule screen of a preset period. It is possible to set a different period depending on whether the rotational motion is made to the right side or to the left side. For example, when the rotational motion is made to the left side, the screen is switched to a schedule screen having a schedule period of one week, as shown by (b) in FIG. 4. In contrast, when the rotational motion is made to the right side, the screen is switched to a schedule screen having a schedule period of two weeks, as shown by (c) in FIG. 4. Here, it is possible to modify the schedule period to be displayed by an ordinary operation to input unit 104, not only by the rotational motion of display unit 105.

Once display unit 105 is rotated from the default vertical position state to the horizontal position state, and the set schedule period is displayed as shown by (b) or (c) in FIG. 4. Thereafter, if display unit 105 is rotated to restore to the original vertical position state, the schedule screen is also restored to the schedule screen before the modification.

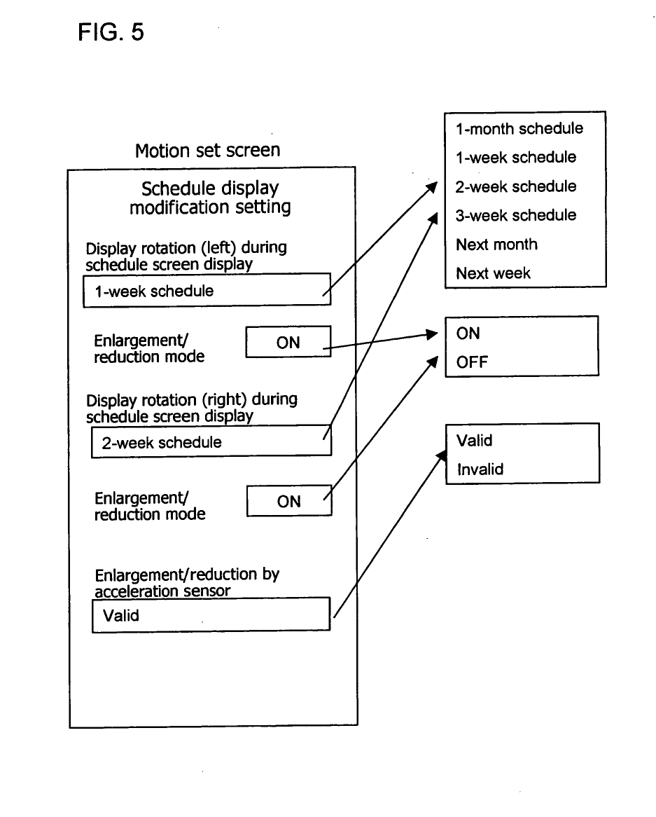

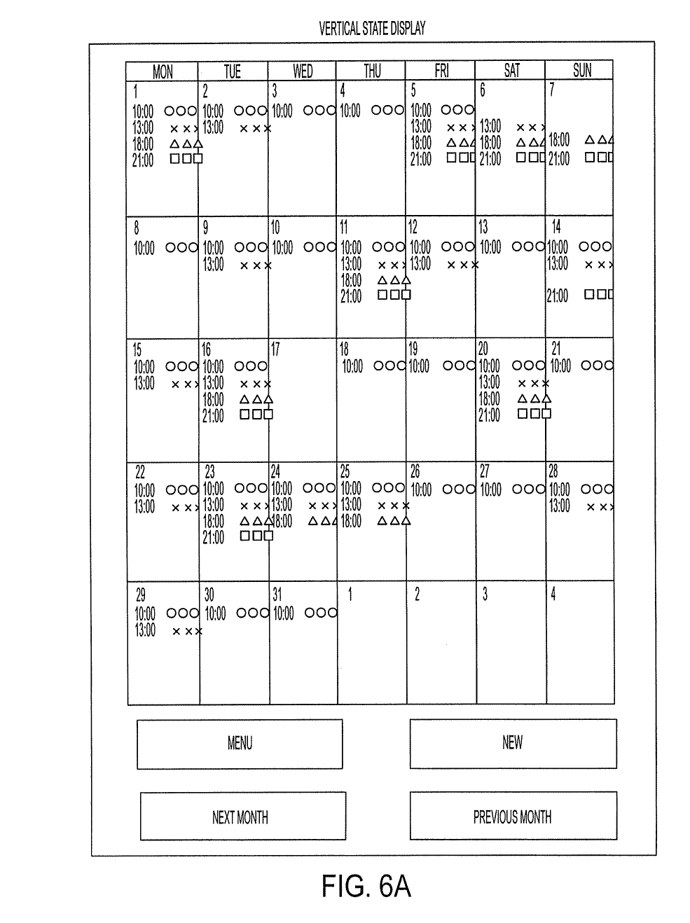

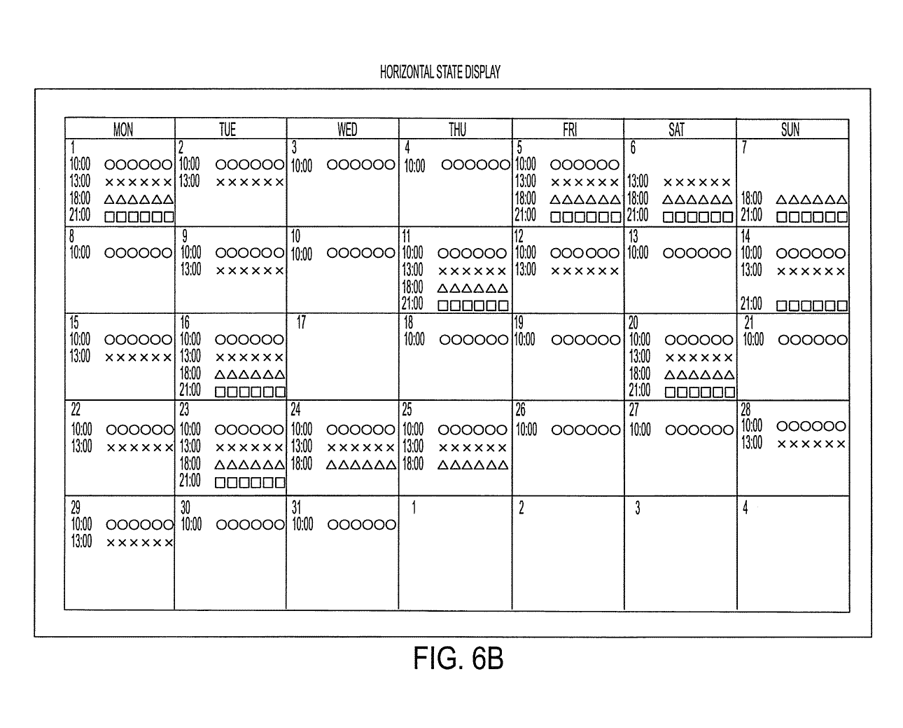

FIG. 5 shows a diagram illustrating an exemplary set screen to set a schedule period to be displayed by the rotational motion of display unit 105. As shown in the figure, the different schedule period is selectable depending on a case of rotation to the left side or a case of rotation to the right side. It may also be possible not to select the schedule period. When display unit 105 is rotated from the vertical position state to the horizontal position state, as shown in FIG. 6, the schedule screen displayed in the vertical position state is adjusted into the horizontal position state to fit to the screen size. When display unit 105 is restored to the vertical position state, the schedule screen is also restored to the vertical position state.

FIGS. 6A, 6B show diagrams illustrating an exemplary switchover of the schedule screen when the schedule period corresponding to the rotational motion is not set. There is shown an example of adjusting the screen size of the schedule screen for one month displayed on display unit 105. The schedule period displayed after the rotational motion is not modified from the schedule period displayed before the rotational motion, and the display contents are merely adjusted to fit to the screen sizes. FIG. 6A shows a case of display unit 105 placed in the vertical position state, while FIG. 6B shows a case of display unit 105 placed in the horizontal position state.

Further, as to a set item of “enlargement/reduction mode” shown in FIG. 5, it is aimed to set whether or not a mode for displaying the schedule being presently displayed with enlargement or reduction is made valid, when display unit 105 is rotated. The operation in the above modes will be described later. Further, as to a set item “enlargement/reduction by acceleration sensor”, it is aimed to set whether or not a mode for displaying the schedule being presently displayed with enlargement or reduction is made valid, when the acceleration sensor detects acceleration. The operation using the acceleration sensor will also be described later.

Next, second display control processing in the embodiment of the present invention is described. In the second display control processing, the display period is modified on detection of a plurality of rotational motions to the left side or to the right side within a certain time period.

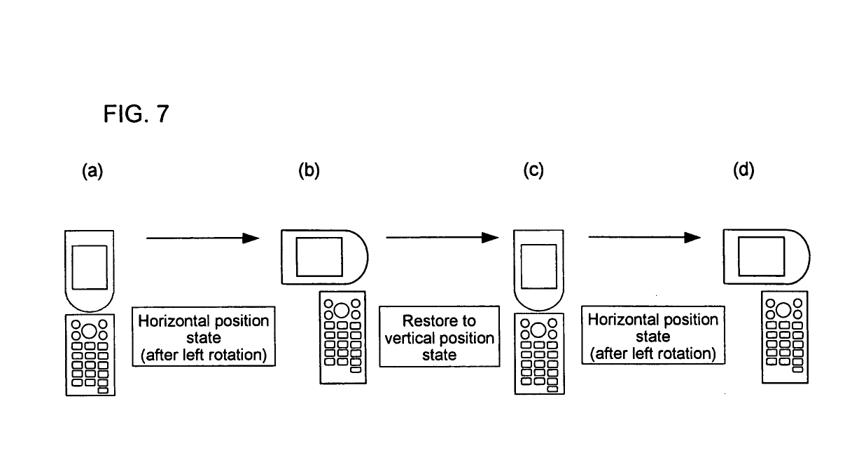

FIG. 7 shows a diagram explaining a motion to rotate display unit 105 so as to modify the display period. The motion to modify the display period is, for example, to rotate display unit 105 in the vertical position state either to the left side or to the right side twice within a certain time period (2 seconds or of that order, for example). Namely, when display unit 105 is placed in the vertical position state [(a) in FIG. 7], display unit 105 is rotated to the left side so as to be placed into the horizontal position state [(b) in FIG. 7], and then rotated so as to be restored to the vertical position state [(c) in FIG. 7], and rotated further to the left side so as to be placed into the horizontal position state [(d) in FIG. 7]. When the above motion is performed within a certain time period, the display period is modified according to the preset sequence of the display periods. At this time, when the user desires to view the schedule screen with display unit 105 kept in the horizontal position state, the user maintains display unit 105 in the horizontal position state intact. On the other hand, when the user desires to view the schedule screen with display unit 105 placed in the vertical position state, the user restores display unit 105 to the vertical position state, and thus the schedule screen is adjusted to the vertical position state and displayed.

When such the plurality of times of rotational motions are detected within a certain time period, the schedule display period to be displayed is modified according to the preset modification sequence.

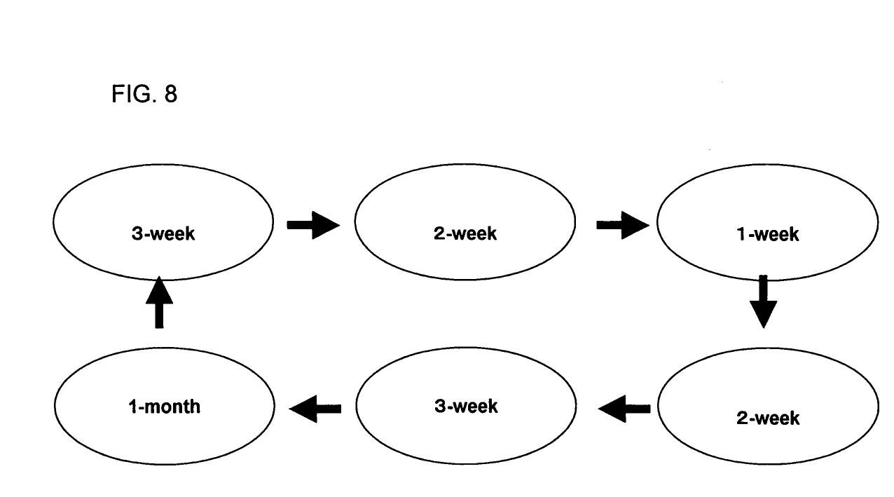

FIG. 8 shows a diagram illustrating an exemplary modification sequence of a schedule display period to be displayed. As shown in the figure, the modification sequence is set to repeat a plurality of display periods periodically, in order of 1 month→3 weeks→2 weeks→1 week→2 weeks→3 weeks→1 month. For example, if the above motion is detected when the schedule display period being presently displayed is 1 month, the schedule display period to be displayed is modified to 3 weeks, and if the above motion is detected further in the present state, the schedule display period is modified to 2 weeks. By repeating the above motions, the schedule display period to be displayed is restored to 1 month, and by repeating the above motions further, the modification of the display period is repeated periodically, according to the same modification sequence.

The aforementioned second display control processing is processing to be executed when the set item “enlargement/reduction mode” shown in FIG. 5 is set OFF. When the above set item is set ON, as third display control processing described below, there is performed an enlargement/reduction display of the schedule by modifying the magnification factor of the display, instead of modifying the schedule display period, when a plurality of times of rotational motions are detected within a certain time period.

More specifically, in the third display control processing, when the plurality of times of rotational motions are detected within the certain time period during the “enlargement/reduction mode” shown in FIG. 5 being set ON, the display magnification factor of the schedule to be displayed is modified according to a predetermined sequence of the display magnification factors.

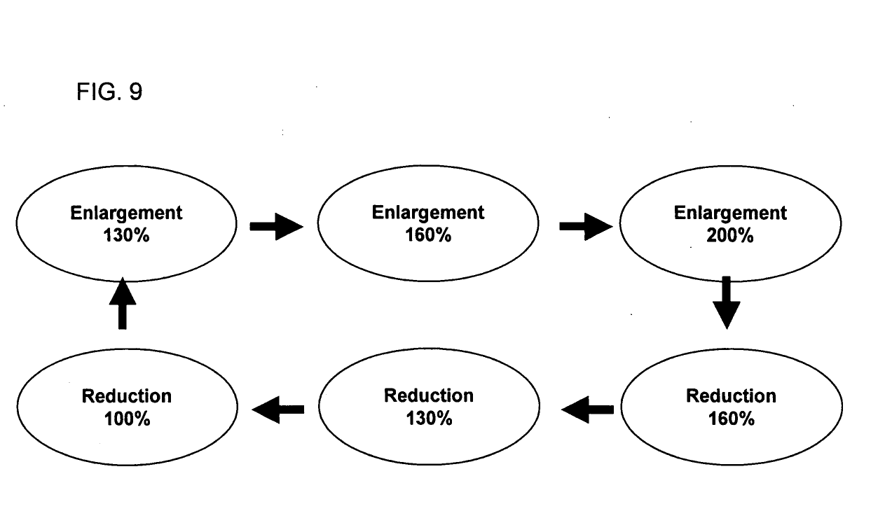

FIG. 9 shows a diagram illustrating an exemplary modification sequence of the display magnification factors of the schedule to be displayed. As shown in the figure, the modification sequence is set in such a manner that a plurality of display magnification factors are periodically repeated to have 130% (enlarged)→160% (enlarged)→200% (enlarged)→160% (enlarged)→160% (reduced)→130% (reduced)→100% (reduced)→130% (enlarged). For example, at the time of ordinary display in which the display magnification factor is 100%, when a first motion among the plurality of times of rotational motions within the certain time period is detected, the display magnification factor is modified to 130%, so as to enlarge the display, and further, when the same motion is detected in the present state, the display magnification factor is modified to 160%, so as to further enlarge the display. When the same motion is detected after the display magnification factor becomes 200%, the display is reversely shifted to a reduced display. By repeating the above-mentioned motions, the display magnification factor of the schedule to be displayed is restored to the ordinary display of 100%. By repeating the above motions further, the modifications of the display magnification factor are repeated periodically, according to the same modification sequence.

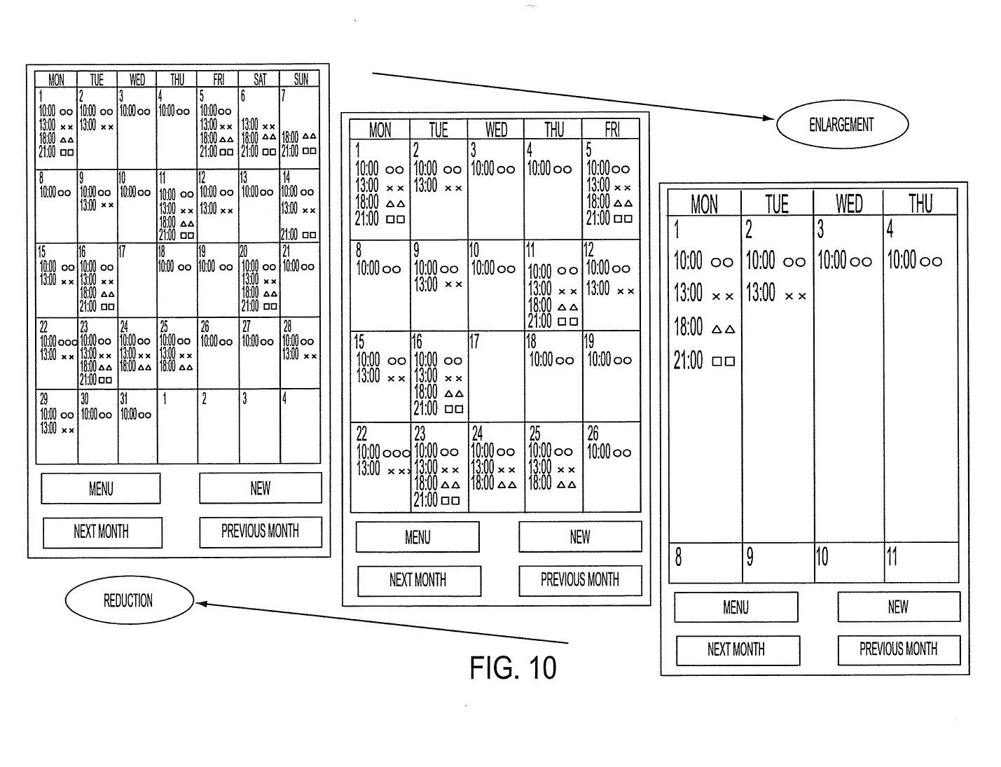

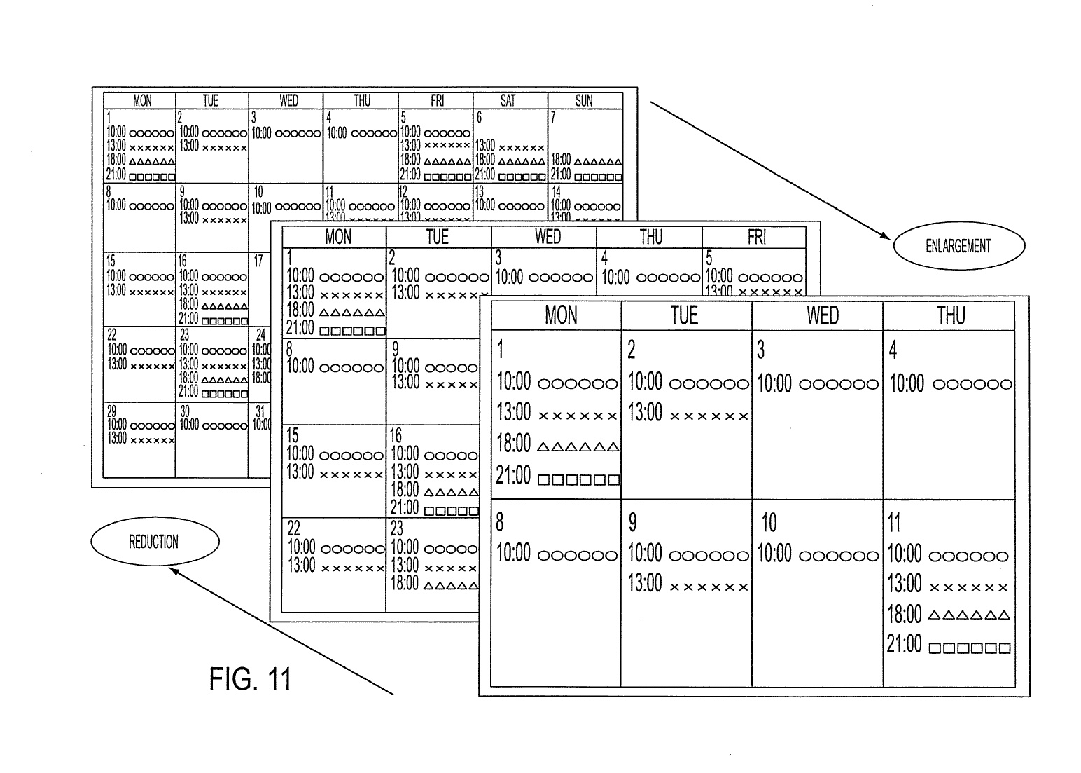

FIGS. 10 and 11 show exemplary schedule screens to be displayed with enlargement/reduction. FIG. 10 shows an example of an enlarged/reduced schedule screen, when display unit 105 is placed in the vertical position state, while FIG. 11 shows an example of an enlarged/reduced schedule screen, when display unit 105 is placed in the horizontal position state.

The aforementioned second display control processing and the third display control processing perform modification of the schedule display period or the display magnification factor when rotation detector 108 detects the rotational motions of display unit 105 for the plurality of times within the certain time period. However, in place of rotation detector 108, it may also be possible to modify the schedule display period or the display magnification factor, by means of acceleration sensor 109 on detecting that display unit 105 is vibrated with a certain acceleration value or greater. Also, it may be possible to make coexist the modification processing of the schedule display period or the display magnification factor, based on the rotation detection of display unit 105, and the modification processing of the schedule display period or the display magnification factor, based on the vibration detection of the mobile terminal apparatus. In this case, on detection of either the rotational motion of display unit 105 or the vibrational motion of the mobile terminal apparatus, the schedule display period or the display magnification factor is modified.

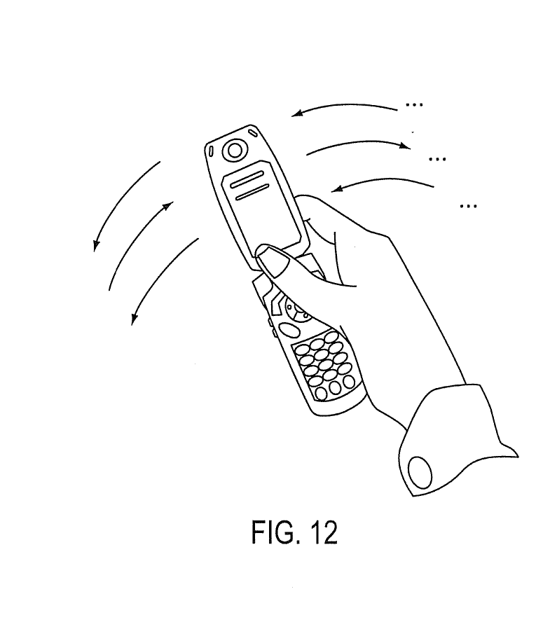

FIG. 12 shows a diagram explaining a motion to vibrate the mobile terminal apparatus so as to modify the display period or the display magnification factor. For example, during a certain time period (2 seconds, for example), the mobile terminal apparatus is vibrated twice, with a predetermined acceleration value or greater. For example, as shown in the figure, when the user swings the mobile terminal apparatus in order of (1) to a first direction, (2) to a second direction opposite to the first direction, and (3) to the first direction again, acceleration sensor 109 detects twice the acceleration of the predetermined value or greater, to the direction of at least first direction. When the above motions are performed within the certain time period, the display period or the display magnification factor is modified according to the preset sequence of the display periods or the display magnification factors.

Similar to the above description, in the case of detecting the acceleration, if the set item “enlargement/reduction mode” shown in FIG. 5 is set OFF, the display period is modified, while if the above set item is set ON, the display magnification factor is modified. The motion to modify either the display period or the display magnification factor is not limited to such the case of vibrating for the plurality of times as described above, to the first direction. Instead, a case of vibrating only once may be applicable, and also, even in the case of vibrating for a plurality of times, the modification control of the display period or the display magnification factor may be performed by the combination of the number of times of vibrations to the first direction and the number of times of vibrations to the second direction. For example, the display modification control is performed on detection of the vibrations to the first direction twice (the acceleration of a predetermined value or greater) produced by the above-mentioned motions of (1) and (3). However, in addition thereto, a one-time detection of the vibration to the second direction caused by the above (2) may be applied to the conditions for performing the display modification control.

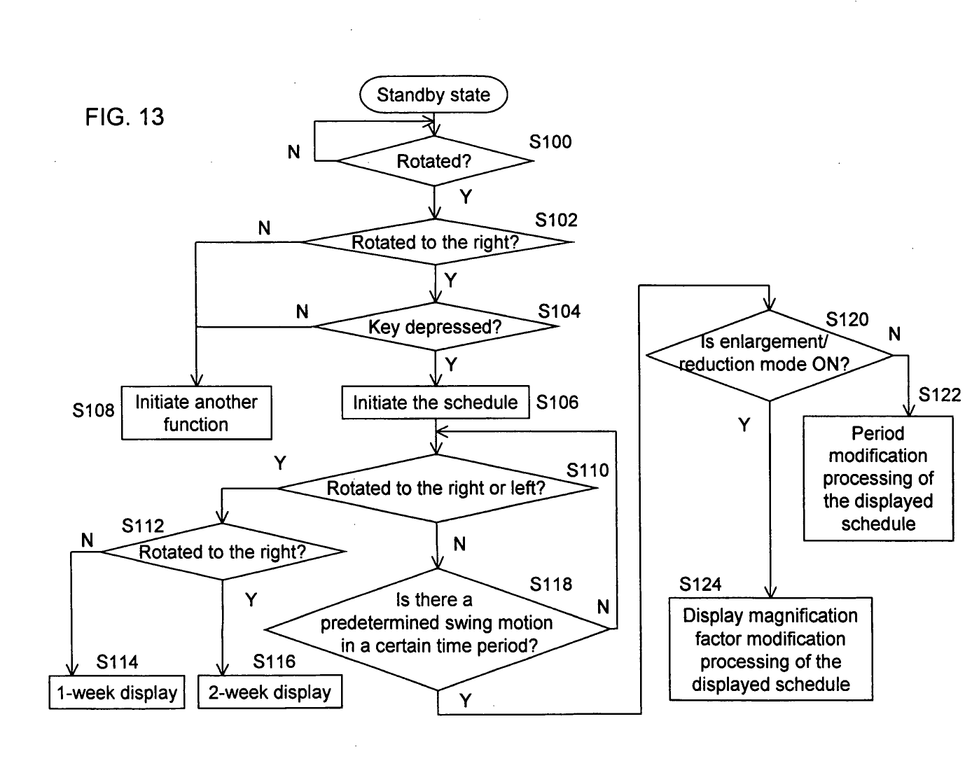

FIG. 13 shows a processing flowchart of the mobile terminal apparatus according to the embodiment of the present invention. The aforementioned control processing is represented in the flowchart, which is executed by application CPU 103. In the state of display unit 105 of the mobile terminal apparatus displaying a standby screen, when the rotational motion of display unit 105 from the vertical position state to the horizontal position state is detected (S100), the direction of the above rotational motion is decided (S102). In case of being rotated to the right side, when the above rotational motion is detected further, it is decided whether a predetermined operation to the input unit 104, such as a depression of a predetermined key, is in progress (S104). When display unit 105 is rotated to the right side in the state the predetermined operation to the input unit 104 is in progress, the schedule function is initiated (S106), and the default screen of the schedule function is displayed. When display unit 105 is rotated in the state the predetermined operation to the input unit 104 is not in progress, or when display unit 105 is rotated to the left side in the state the predetermined operation to the input unit 104 is in progress, functions different from the schedule function are initiated respectively (S108).

After the schedule function is initiated, on detection of display unit 105 being rotated from the vertical position state to the horizontal position state (S110), further, the direction of the rotational motion is decided (S112) Then, according to the setting by use of the set screen shown in FIG. 5, the schedule period to be displayed is modified. Further, depending on the direction of the rotational motion, the schedule of a different period is displayed. For example, in the example shown in FIG. 4, the schedule for one week is displayed when being rotated to the left side (S114), while the schedule for two weeks is displayed when being rotated to the right side (S116). The schedule periods to be displayed are arbitrarily settable, using the set screen shown in FIG. 5.

Also, while the schedule function is active, if a predetermined swing motion is detected within a certain time period (S118), the modification control of the display period or the display magnification factor is performed. The predetermined swing motion within the certain time period is the rotational motion of display unit 105 for a plurality of times within the certain time period, or the vibrational motion of the mobile terminal apparatus with a predetermined acceleration value, or greater, for a plurality of times within the certain time period.

When the predetermined swing motion is detected, the ON/OFF of the “enlargement/reduction mode” set by using the set screen shown in FIG. 5 is decided (S120). In the case of OFF, the schedule period to be displayed is modified according to the example shown in FIG. 8, while in the case of ON, the display magnification factor of the schedule to be displayed is modified according to the example shown in FIG. 9.

In addition to the above-mentioned embodiment, a variety of other embodiments included in the scope of the present invention may be considered.

For example, in the above-mentioned embodiment, using the set screen shown in FIG. 5, it is possible to set the schedule period to be displayed when display unit 105 is rotated from the vertical position state to the horizontal position state. However, it is also possible to make settable the schedule period to be displayed when the mobile terminal apparatus is swung, namely, when acceleration sensor 109 detects the acceleration of a predetermined value or greater.

Also, there has been described the example of modifying the display magnification factor when the predetermined rotational motion is performed within a certain time period, such as the plurality of times of rotational motions within the certain time period. However, it may also be possible to modify the display magnification factor simply by a one-time rotational motion. In this case, different display magnification factors may be set depending on the rotational motion to the right side or to the left side so as to shift from the vertical position state to the horizontal position state. For example, in the set screen shown in FIG. 5, in place of the schedule periods respectively to be settable to the rotational motions to the right side and to the left side, it is possible to make the display magnification factors settable.

According to the present invention, it becomes possible to modify the schedule period to be displayed of the display magnification factor by means of a predetermined swing motion to the mobile terminal apparatus, instead of a key operation, which enables improved operability of the schedule function, as well as easy reading of the schedule contents.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A mobile terminal apparatus having a schedule function to store and display a schedule, comprising:
a display unit displaying the stored schedule;
a swing detection unit detecting a swing motion of the display unit; and
a display control unit modifying a schedule period to be displayed on the display unit, when the swing detection unit detects the swing motion of the display unit.

2. The mobile terminal apparatus according to claim 1,
wherein the swing motion of the display unit is a rotational motion of the display unit from the vertical position state to the horizontal position state, and a rotational motion from the horizontal position state to the vertical position state.

3. The mobile terminal apparatus according to claim 2,
wherein, when the swing detection unit detects the rotational motion of the display unit from the vertical position state to the horizontal position state, the display control unit modifies a first schedule period displayed on the display unit to a second schedule period.

4. The mobile terminal apparatus according to claim 3,
wherein the swing detection unit detects whether the direction of the rotational motion of the display unit is to the right direction or to the left direction, and
when the rotational motion to the left direction is detected, the display control unit modifies a first schedule period displayed on the display unit to a second schedule period, while when the rotational motion to the right direction is detected, the display control unit modifies the first schedule period displayed on the display unit to a third schedule period.

5. The mobile terminal apparatus according to claim 2,
wherein, whenever the swing detection unit detects a predetermined rotational motion of the display unit within a predetermined time, the display control unit modifies the schedule period to be displayed on the display unit, according to a preset modification sequence of the plurality of the schedule periods.

6. The mobile terminal apparatus according to claim 5,
wherein the predetermined rotational motion of the display unit includes a plurality of times of rotational motions of the display unit from the vertical position state to the horizontal position state.

7. The mobile terminal apparatus according to claim 2, further comprising:
an input unit for performing an input operation,
wherein, while a standby screen is displayed on the display unit, when the swing detection unit detects the rotational motion of the display unit from the vertical position state to the horizontal position state during a predetermined input operation to the input unit, the display control unit initiates the schedule function, so as to display a predetermined schedule period.

8. The mobile terminal apparatus according to claim 1,
wherein the swing motion of the display unit is a vibration of the display unit with a predetermined acceleration value or greater.

9. The mobile terminal apparatus according to claim 8,
wherein, whenever the swing detection unit detects a predetermined vibrational motion of the display unit within a predetermined time, the display control unit modifies the schedule period to be displayed on the display unit, according to a preset modification sequence of the plurality of the schedule periods.

10. The mobile terminal apparatus according to claim 9,
wherein the predetermined vibrational motion of the display unit includes a plurality of times of vibrational motions of the display unit to predetermined directions.

11. A mobile terminal apparatus having a schedule function to store and display a schedule, comprising:
a display unit displaying the stored schedule;
a swing detection unit detecting a swing motion of the display unit; and
a display control unit modifying a display magnification factor of the schedule to be displayed on the display unit, when the swing detection unit detects the swing motion of the display unit.

12. The mobile terminal apparatus according to claim 11,
wherein the swing motion of the display unit is a rotational motion of the display unit from the vertical position state to the horizontal position state, and a rotational motion from the horizontal position state to the vertical position state.

13. The mobile terminal apparatus according to claim 12,
wherein, when the swing detection unit detects the rotational motion of the display unit from the vertical position state to the horizontal position state, the display control unit modifies the display magnification factor of the schedule displayed on the display unit, from a first display magnification factor to a second display magnification factor.

14. The mobile terminal apparatus according to claim 13,
wherein the swing detection unit detects whether the direction of the rotational motion of the display unit is to the right direction or to the left direction, and
when the rotational motion to the left direction is detected, the display control unit modifies the display magnification factor of the schedule displayed on the display unit, from the first display magnification factor to the second display magnification factor, while when the rotational motion to the right direction is detected, the display control unit modifies the display magnification factor of the schedule displayed on the display unit, from the first display magnification factor to a third display magnification factor.

15. The mobile terminal apparatus according to claim 12,
wherein, whenever the swing detection unit detects a predetermined rotational motion of the display unit within a predetermined time, the display control unit modifies the display magnification factor of the schedule to be displayed on the display unit, according to a preset modification sequence of the plurality of the display magnification factors.

16. The mobile terminal apparatus according to claim 15,
wherein the predetermined rotational motion of the display unit includes a plurality of times of rotational motions of the display unit from the vertical position state to the horizontal position state.

17. The mobile terminal apparatus according to claim 12, further comprising:
an input unit for performing an input operation,
wherein, while a standby screen is displayed on the display unit, when the swing detection unit detects the rotational motion of the display unit from the vertical position state to the horizontal position state during a predetermined input operation to the input unit, the display control unit initiates the schedule function, so as to display the schedule with a predetermined display magnification factor.

18. The mobile terminal apparatus according to claim 11,
wherein the swing motion of the display unit is a vibration of the display unit with a predetermined acceleration value or greater.

19. The mobile terminal apparatus according to claim 18,
wherein, whenever the swing detection unit detects a predetermined vibrational motion of the display unit within a predetermined time, the display control unit modifies the display magnification factor of the schedule to be displayed on the display unit, according to a preset modification sequence of the plurality of the display magnification factors.

20. The mobile terminal apparatus according to claim 19,
wherein the predetermined vibrational motion of the display unit includes a plurality of times of vibrations of the display unit to predetermined directions.

21. A display control method of a mobile terminal apparatus having a schedule function to store and display a schedule, comprising:
a display step for displaying the schedule on a display unit of the mobile terminal apparatus;
a swing detection step for detecting swing motion of the display unit; and
a display control step for modifying a schedule period to be displayed on the display unit, when the swing motion of the display unit is detected in the swing detection step.

22. A display control method of a mobile terminal apparatus having a schedule function to store and display a schedule, comprising:
a display step for displaying the schedule on a display unit of the mobile terminal apparatus;
a swing detection step for detecting a swing motion of the display unit; and
a display control step for modifying a display magnification factor of the schedule to be displayed on the display unit, when the swing motion of the display unit is detected in the swing detection step.

23. A computer program executed in a mobile terminal apparatus having a schedule function to store and display a schedule, enabling the mobile terminal apparatus to execute:
a display step for displaying the schedule on a display unit of the mobile terminal apparatus;
a swing detection step for detecting a swing motion of the display unit; and
a display control step for modifying a schedule period to be displayed on the display unit, when the swing motion of the display unit is detected in the swing detection step.

24. A computer program executed in a mobile terminal apparatus having a schedule function to store and display a schedule, enabling the mobile terminal apparatus to execute:
a display step for displaying the schedule on a display unit of the mobile terminal apparatus;
a swing detection step for detecting a swing motion of the display unit; and
a display control step for modifying a display magnification factor of the schedule to be displayed on the display unit, when the swing motion of the display unit is detected in the swing detection step.
